(19) United States
(12) Patent Application Publication
(10) Pub. No.: US 2011/0304271 A1
(43) Pub. Date: Dec. 15, 2011

(54) Light-emitting diode (LED) protection structure

(75) Inventors: Yi-Yu Tsai, San Chung City (TW); Yi-Hua Li, San Chung City (TW)

(73) Assignee: Unity Opto Technology Co., Ltd., San Chung City (TW)

(21) Appl. No.: 12/805,767

(22) Filed: Aug. 19, 2010

(30) Foreign Application Priority Data
Jun. 14, 2010 (TW) 099211294

(51) Int. Cl. H05B 37/02

(52) U.S. Cl. 315/125

(57) ABSTRACT

A light-emitting diode (LED) protection structure includes an LED portion and a protection portion. The protection portion includes a fuse and a Zener diode connected in series. The protection portion is electrically connected to the LED portion in parallel but opposite in direction. As such, the LED protection structure can effectively protect the LEDs and the Zener diode from being damaged to thereby reduce costs.

### FIELD OF THE INVENTION

The present invention relates to a light-emitting diode (LED) protection structure and in particular to an LED protection structure comprising a switch and a Zener diode.

### BACKGROUND OF THE INVENTION

After the invention of lighting bulb by Thomas Alva Edison, lighting becomes essential to human society. The subsequent development of fluorescent tubes further upgraded lighting technology. In 1960, a light-emitting diode (LED) made a new page of human lighting history and the LED brings new hope to the lighting industry with its characteristics of power saving, long lasting service life, and reduced heat generation. Due to technical constraints, it was only after 1993 that a blue LED was successfully developed to completely satisfy visual sense of human eyes for primary colors of red, green, and blue. This further advances the application of LED.

Being similar to general electronic devices, an LED is susceptible to damage caused by abnormal electric phenomenon, such as electrostatic discharge, surge, or inrush current, during the manufacturing process or the use thereof. This is an even severer problem for GaN series LED products, including products of blue light, green light, white light, and ultraviolet light, for the GaN material is weak in resisting static electricity and thus it is easily damaged by static electricity during the use thereof. Apparently, to protect an LED from damages caused by electrostatic discharge during the manufacturing and use thereof is an important issue for designing and using LEDs.

Manufacturers adopt a solution of adding a Zener diode in the design of LED-included circuits in such a way that the Zener diode and the LEDs are arranged in parallel but opposite in direction. Under a normal condition, when a forward working voltage is applied, the input voltage causes the conduction of current through only the LEDs to give off light, but not the Zener diode. However, when an abnormal electrical phenomenon, such as electrostatic discharge, surge, or inrush current, occurs, an excessively large voltage is caused and such a large voltage makes the Zener diode breaking down, conducting most of the current through the Zener diode rather than the LEDs.

However, the manufacturing of Zener diode is complicated, making it not easy to lower down the manufacturing cost thereof. Thus, it is desired to prevent both the LEDs and the Zener diode from being damaged in an abnormal electrical phenomenon in order to further reduce the manufacturing cost.

### SUMMARY OF THE INVENTION

An objective of the present invention is to provide a light-emitting diode (LED) protection structure, which comprises a switch that is arranged in front of a Zener diode to protect the Zener diode that is of a high manufacturing cost, so as to provide an efficacy of lowering the cost of using LED circuits.

To realize the above objective, the present invention provides an LED protection structure, which comprises an LED portion and a switching portion. The switching portion comprises a switching element, a secondary conductor, and a Zener diode. The switching portion is electrically connected in parallel to the LED portion with the Zener diode connected in opposite direction. The switching element is selectively set in a first position where the Zener diode and the LED portion conduct and a second position where the secondary conductor and the LED portion conduct.

In a preferred embodiment according to the present invention, the LED portion comprises at least one serially-connected LED. It is also possible to use a number of LEDs that are put in parallel electrical connection. To accommodate diverse LED circuits, the LED portion may be composed of multiple serially-connected LED sets, wherein the multiple serially-connected LED sets are electrically connected in parallel to each other and each serially-connected LED set comprises at least one LED connected in series.

### BRIEF DESCRIPTION OF THE DRAWINGS

The present invention will be apparent to those skilled in the art by reading the following description of preferred embodiments thereof with reference to the drawings, in which:

FIG. 1A is a schematic circuit diagram showing a light-emitting diode (LED) protection structure according to a first embodiment of the present invention with a switching element set in a first position;

FIG. 1B is a schematic circuit diagram showing the light-emitting diode (LED) protection structure according to the first embodiment of the present invention with the switching element in a second position

FIG. 2A is a schematic circuit diagram showing an LED protection structure according to a second embodiment of the present invention with a switching element set in a first position;

FIG. 2B is a schematic circuit diagram showing the LED protection structure according to the second embodiment of the present invention with the switching element in a second position;

FIG. 3A is a schematic circuit diagram showing an LED protection structure according to a third embodiment of the present invention with a switching element set in a first position; and

FIG. 3B is a schematic circuit diagram showing the LED protection structure according to the third embodiment of the present invention with the switching element in a second position.

### DETAILED DESCRIPTION OF THE PREFERRED EMBODIMENTS

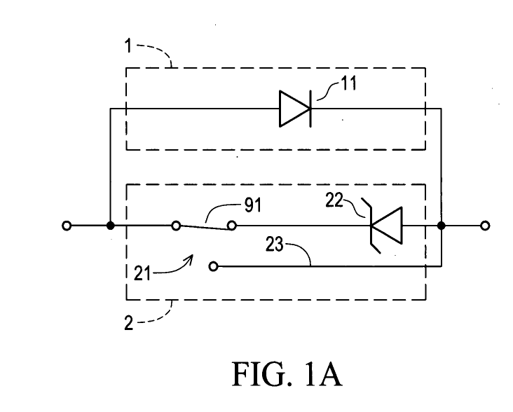

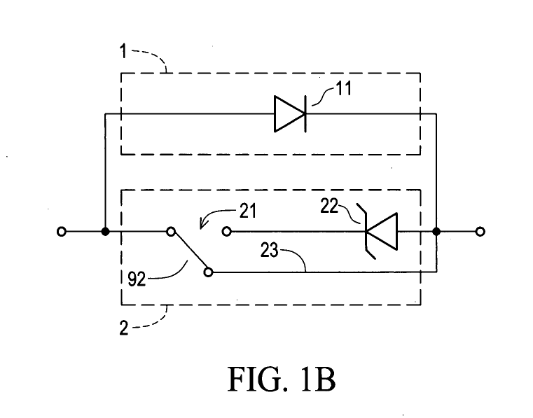

With reference to the drawings and in particular to FIGS. 1A and 1B, which show a schematic circuit diagram of a light-emitting diode (LED) protection structure according to a first embodiment of the present invention, the LED protection structure according to the present invention comprises an LED portion 1 and a switching portion 2. In the embodiment illustrated, to simplify the description, only one LED 11 is shown for the LED portion 1. It is apparent that it can be made in such an arrangement that more than one LED 11 is electrically connected in series. The LED 11 can be a GaN series LED. The switching portion 2 comprises a switching element 21, a secondary conductor 23, and a Zener diode 22. The switching portion 2 is electrically connected in parallel to the LED portion 1 with the Zener diode 22 connected in opposite direction.

With such an arrangement of the LED protection structure according to the present invention, in a normal condition, the switching element 21 is set in a first position 91, making the Zener diode 22 and the LED portion 1 conducting. Under this condition, an input voltage causes a forward biasing between opposite ends of the LED portion 1 to conduct electrical current therethrough, making the LED 11 emitting. light. However, such an input voltage induces a reversed biasing between opposite ends of the switching portion 2, so that the protection portion 2 is in an open-circuit condition. When an abnormal electrical phenomenon, such as electrostatic discharge, surge, or inrush current, an instantaneous excessively-large input voltage, which is not large enough to damage the Zener diode 22, is caused, since the switching element 21 is in the first position 91, the Zener diode 22 and the LED portion 1 are still conducting, eventually causing breakdown of the Zener diode 22 so that most of the electrical current flows through the Zener diode 22 rather than the LED 11, whereby the LED 11 is protected. However, once the instantaneous input voltage exceeds the breakdown voltage of the Zener diode 22, the Zener diode 22 may be damaged by such a voltage. Under such a condition, the switching element 21 is set in a second position 92, where the secondary conductor 23, as well as the LED portion 1, is conducts, allowing all the input voltage to pass through the secondary conductor 23 and thus protecting the LED lighting circuit. Afterwards, after abnormal input of voltage completely passes through the secondary conductor 23, the circuit resumes normal operation and the switching element 21 returns to the first position 91, making the Zener diode 22 and the LED portion 1 conducting again.

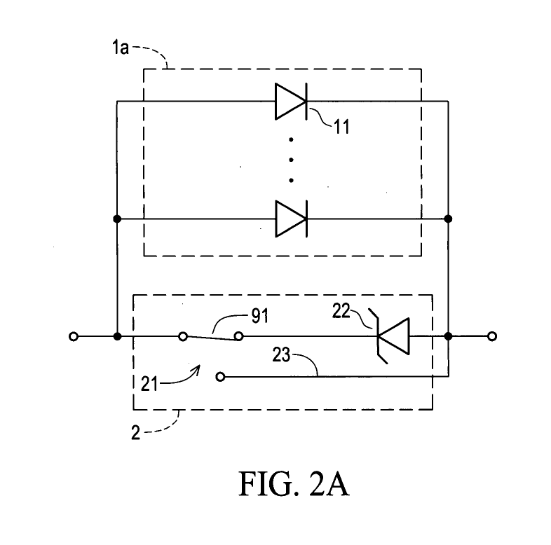

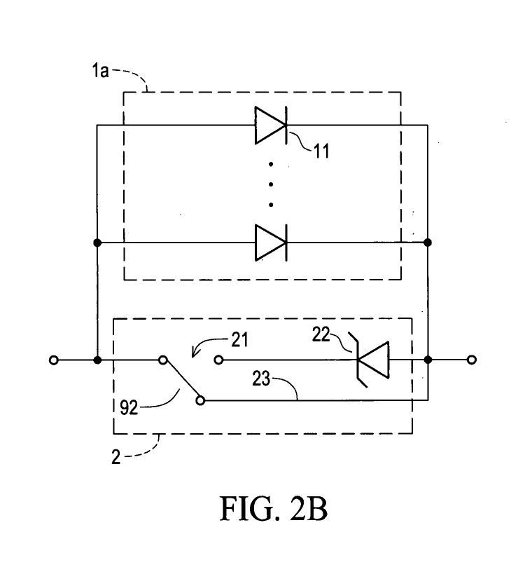

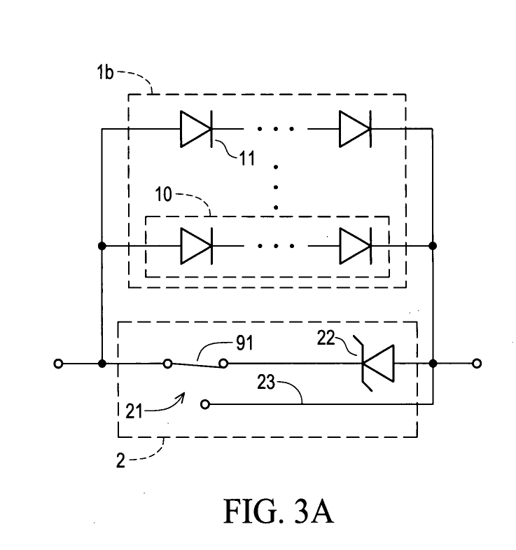

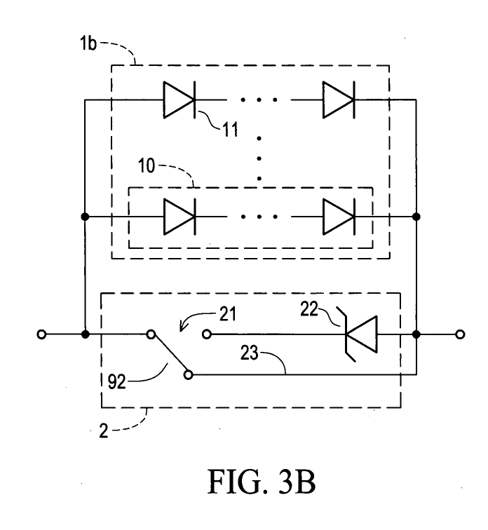

In the following descriptions of other embodiments of the present invention, since most of the components/parts are similar to the counterparts thereof adopted to the previously described embodiment, these components/parts that are identical or similar to each other will bear the same reference numerals with only a postfix character added for distinction. And, repeated description of the identical components/parts/portions will be omitted. Reference is now made to FIGS. 2A and 2B, which show a schematic circuit diagram of an LED protection structure according to a second embodiment of the present invention. To accommodate different structures of LED circuit, the second embodiment of the present invention provides an LED protection structure that comprises an LED portion 1a that is composed of a plurality of LEDs 11 electrically connected to each other in parallel. Further referring to FIGS. 3A and 3B, which show a schematic circuit diagram of an LED protection structure according to a third embodiment of the present invention, in which the LED protection structure according to the present invention comprises an LED portion 1b that is composed of multiple serially-connected LED sets 10, which are electrically connected to each other in parallel. Each of the serially-connected LED set 10 comprises at least one serially-connected LED 11.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A light-emitting diode (LED) protection structure, comprising:
an LED portion; and
a switching portion, which comprises a switching element, a secondary conductor, and a Zener diode, the switching portion being electrically connected in parallel to the LED portion with the Zener diode connected in opposite direction, wherein the switching element is selectively set in a first position where the Zener diode and the LED portion conduct and a second position where the secondary conductor and the LED portion conduct.

2. The LED protection structure as claimed in claim 1, wherein the LED portion comprises at least one LED connected in series.

3. The LED protection structure as claimed in claim 1, wherein the LED portion comprises a plurality of LEDs electrically connected to each other in parallel.

4. The LED protection structure as claimed in claim 1, wherein the LED portion comprises multiple LED sets, which are electrically connected to each other in parallel, each of the LED sets comprising at least one LED connected in series.
